(19) United States
(12) Patent Application Publication
(10) Pub. No.: US 2002/0092181 A1
(43) Pub. Date: Jul. 18, 2002

(54) 4-in-1 meal tools

(76) Inventor: Yat Fay Choi, Monterey Park, CA (US)

Correspondence Address: Raymond Yat Chiu Chan, 1050 Oak Dale Lane, Arcadia, CA, 91006, US

(21) Appl. No.: 09/760,338

(22) Filed: Jan. 16, 2001

(51) Int. Cl. A47J 43/28

(52) U.S. Cl. 30/324

(57) ABSTRACT

A 4-in-i meal tool includes a pair of first and second chopsticks each having a distal end, a spoon member having a distal end and a proximal end functioned in a manner of spoon wherein the distal end of the first chopstick is adapted for detachably attaching to the proximal end of the spoon member, so as to form a handle of the spoon member, and a knife member having a distal end and a proximal end functioned in a knife manner wherein the distal end of the second chopstick is adapted for detachably attaching to the proximal end of the knife member, so as to form a handle of the spoon member. Thus, at least a tooth is integrally extended from the distal end of the spoon member which is functioned in a manner of knife. So, the 4-in-1 meal tool is capable of performing as a fork, spoon, knife, and chopstick in one utensil.

### BACKGROUND OF THE PRESENT INVENTION

1. Field of Invention

The present invention relates to meal tools, and more particularly to a 4-in-1 meal tool which is a combination of eating utensil including chopstick, forks, spoons, and knives, so as to facilitate for carriage and use everywhere.

2. Description of Related Arts

Every culture has its own food style. For Oriental foods, such as Chinese and Japanese foods, chopsticks are the major eating utensils, which requires a particular technical in order to well manipulate by the user. For Western-style foods, forks, knives, and spoons are the well known eating utensils. However, for a meal, each single person must be provided a whole set of eating utensil including the fork, knife, and spoons, which will take lots of spaces of the table. Thus, the improperly setting of the eating utensil may destroy the aesthetic appearance of the whole table setting.

In order to solve the above drawbacks, different types of combination of the eating utensils are provided. For example, U.S. pat. No. 5,056,173, owned by Brincat, discloses a combination fork and chopsticks for picking up and eating food. However, a chopsticks portion is integrally connected with the fork portion in order to form a one-piece member. However, the integral chopsticks portion is hard for the user to grasp the foods in a tweezer-like manner.

Another example is U.S. Pat. No. 4,535,538, owned by Nelson, discloses a combination non-disposable table utensil which is capable of performing as a knife, fork, or spoon. However, for Oriental people, they are used to use chopsticks that the combination non-disposable table utensil may not fit for their eating habit. Thus, the user normally needs a knife and a fork separately in order to cut and grasp the food at the same time. So, the combination non-disposable table utensil is not suit for daily usage.

### SUMMARY OF THE PRESENT INVENTION

A main object of the present invention is to provide a 4-in-1 meal tool which is capably of performing as a fork, spoon, knife, and chopstick in one set of meal tool.

Another object of the present invention is to provide a 4-in-1 meal tool which is facilitated to be assembled and disassembled for use and carriage.

Another object of the present invention is to provide a 4-in-1 meal tool which can provide an aesthetic appearance of the table setting.

Another object of the present invention is to provide a 4-in-1 meal tool that is simple and easy to use.

Another object of the present invention is to provide a 4-in-1 meal tool which is compact and economical in cost to manufacture.

Accordingly, in order to accomplish the above objects, the present invention provides a 4-in-1 meal tool, which comprises:

a pair of first and second chopsticks each having a distal end;

a spoon member having a distal end and a proximal end wherein the distal end of the first chopstick is adapted for detachably attaching to the proximal end of the spoon member, so as to form a handle of the spoon member; and

a knife member having a distal end and a proximal end wherein the distal end of the second chopstick is adapted for detachably attaching to the proximal end of the knife member, so as to form a handle of the spoon member.

### BRIEF DESCRIPTION OF THE DRAWINGS

FIG. 1 is a perspective view of a 4-in-1 meal tool according to a preferred embodiment of the present invention.

FIG. 2 is an exploded perspective view of the 4-in-1 meal tool according to the above preferred embodiment of the present invention.

FIG. 3 is a sectional view of the spoon member and the knife member the 4-in-1 meal tool according to the above preferred embodiment of the present invention.

### DETAILED DESCRIPTION OF THE PREFERRED EMBODIMENT

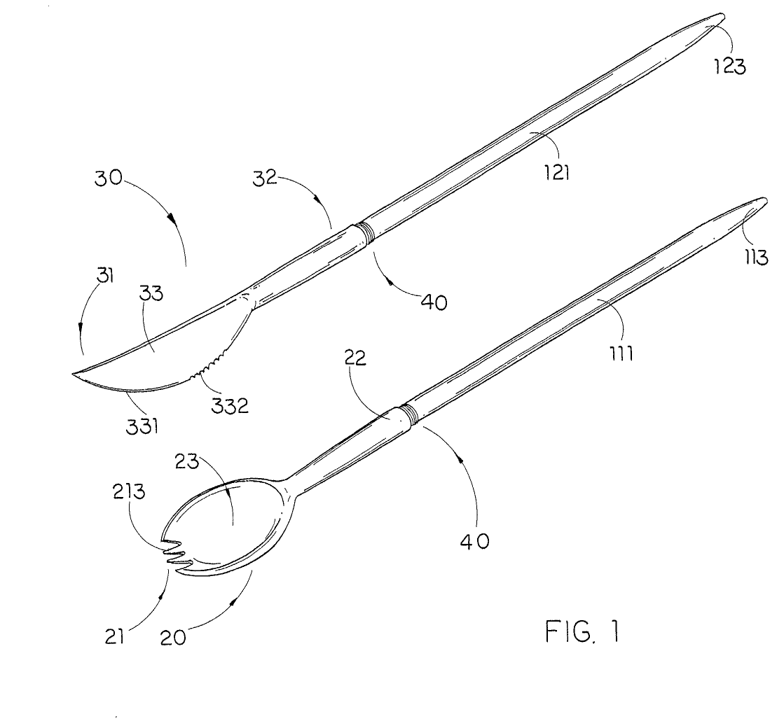

Referring to FIG. 1 of the drawings, a 4-in-1 meal tool according to a preferred embodiment of the present invention is illustrated, wherein the 4-in-1 meal tool is capably of performing as a fork, spoon, knife, and chopstick in one set of meal tool. The 4-in-1 meal tool comprises a pair of first and second chopsticks 11, 12, a spoon member 20, and a knife member 30.

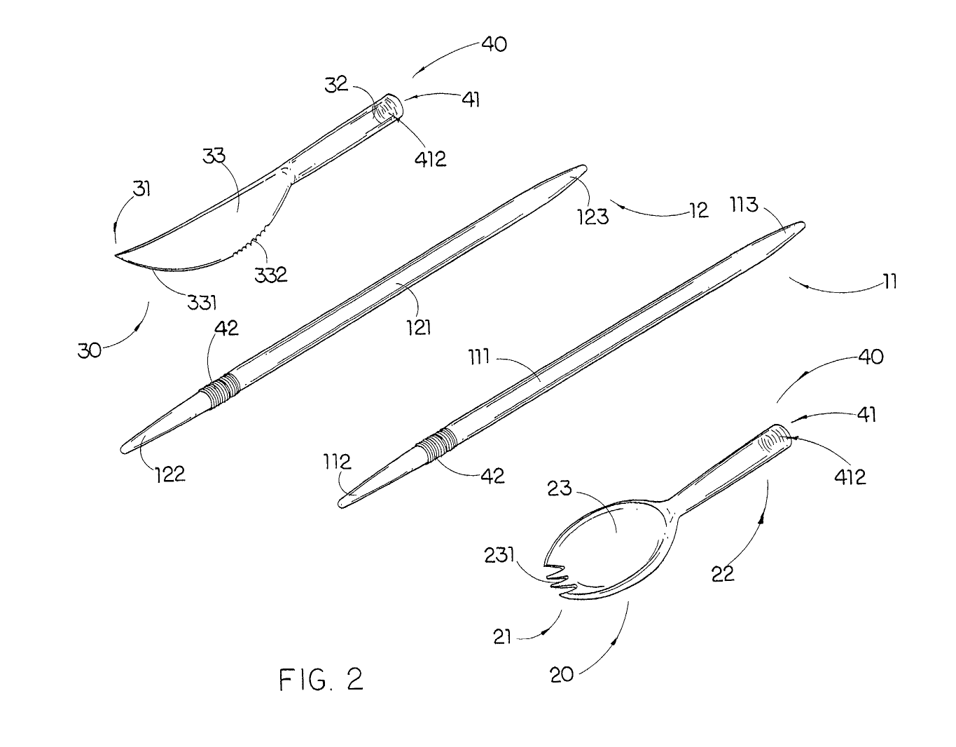

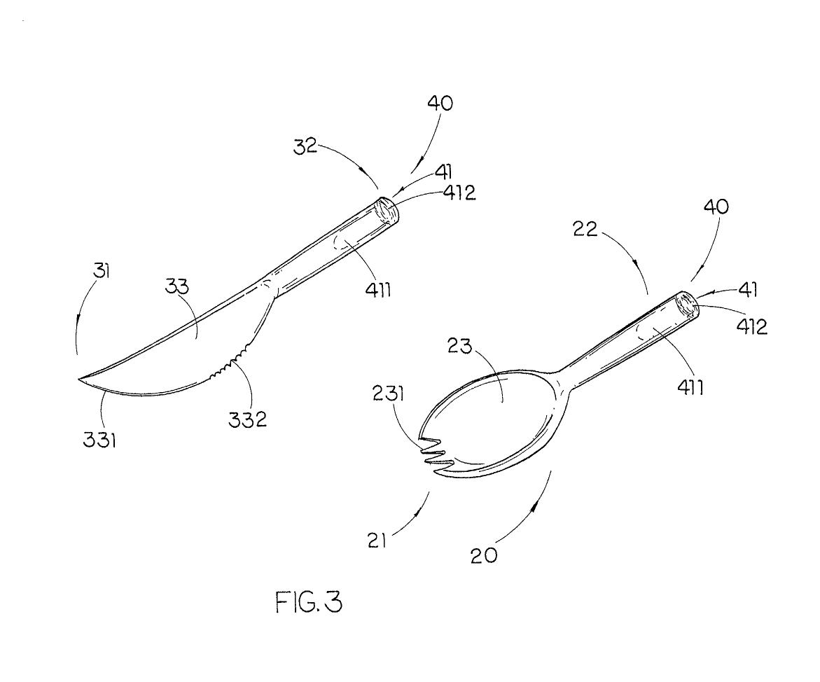

As shown in FIGS. 2 and 3, each of the first and second chopsticks 11, 12 comprises a slender body 11, 112 having a distal end 112, 122 and a proximal end 113, 123 wherein a user is able to manipulate the slender bodies 111, 121 of the first and second chopsticks 11, 12 to grasp the foods at the distal ends 112, 122 thereof in a tweezer-like manner as conventional chopsticks. Preferably, the slender body 111, 121 of each first and second chopsticks 11, 12 has a diameter gradually increase from the distal end 112, 122 to a mid portion thereof and then gradually decrease to the proximal end 113, 123 of the slender body 11, 12. In other words, the distal end 112, 122 of each of the first and second chopsticks 11, 12 has a tapered shape for grasping the foods easily.

The spoon member 20 has a distal end 21 and a proximal end 22 wherein a scoop 23 having a curved surface is formed at the distal end 21 of the spoon member 20 for retaining the food thereon in such a manner the scoop 23 functions as a spoon. The spoon member 20 further has at least a tooth 231 integrally and outwardly extended from the distal end 21 of the scoop 23 for functioning in a manner of a fork. In other words, the spoon member 20 can be performed as a spoon with the scoop 23 and as a fork with the tooth 231 in one piece member.

The knife member 30 has a distal end 31 and a proximal end 32 wherein a cutting piece 33 is integrally formed at the distal end 31 of the knife member 30 for cutting the food in such a manner that the cutting piece 33 functions as a knife. The cutting piece 33 has a bevel edge 331 and a plurality of tines 332 spacedly provided on the bevel edge 331 for cutting the food easily.

Accordingly, the distal end 112 of first chopstick 11 is adapted for detachably attaching to the proximal end 22 of the spoon member 20, and the distal end 122 of second chopstick 122 is adapted for detachably attaching to the proximal end 32 of the knife member 30, such that the slender bodies 111, 121 of the first and second chopsticks 11, 12 are adapted to form a handle of the spoon member 20 and the knife member 30 respectively.

In order to attach the first and second chopsticks 11, 12 to the spoon member 20 and the knife member 30 respective, the 4-in-1 meal tool further comprises an attaching means 40 to securely mount the distal ends 112, 122 of the first and second chopsticks 11, 12 to the proximal ends 22, 32 of the spoon member 20 and the knife member 30 respectively. The attaching means 40 comprises a holder 41 having a tapered slot 411 provided thereon integrally formed at the proximal ends 22, 32 of the spoon member 20 and knife member 30 respectively such that the distal ends 112, 122 of the first and second chopsticks 11, 12 are fittedly inserted into the tapered slots 411 of the holders 41 respectively. Thus, each holder 41 has an inner threaded portion 412 provided on a circumferential surface of the tapered slot 411 for screwing with an outer threaded portion 42 provided on an outer circumferential surface of the first and second chopsticks 11, 12 respectively. So, the first and second chopsticks 11, 12 are adapted for securely attaching to the spoon member 20 and the knife member 30 respectively.

In a manner of chopsticks, the user simply detaches the spoon member 20 and the knife member 30 from the first and second chopsticks 11, 12, so that the first and second chopsticks 11, 12 are performed as a pair of ordinary chopsticks. For Western style, simply attach the spoon member 20 and the knife member 30 to the first and second member 11, 12 respectively so as to perform as the conventional spoon, knife, and fork. It is worth to mention that the spoon member 20 and the knife member 30 are used in a separated manner so that the user is able to utilize one hand to use the knife member 30 with the second chopstick 12 and another hand to use the spoon member 20 with the first chopstick 11 as the traditionally eating utensil, which does not like the prior art as mentioned in the background that one utensil member functions as the spoon, knife, and fork at all.

Also, the spoon member 20 and the knife member 30 can be made of rigid and durable material such as plastic or metal, and the first and second chopsticks 11, 12 can be made of plastic, metal, or wood, such that the 4-in-1 meal tool is rigid enough to retain or cut the food. Thus, the 4-in-1 meal tool is relatively lightweight, small size, and simple structure, which is facilitated to be assembled and disassembled for use and carriage.

What is claimed is:

1. A 4-in-1 meal tool, comprising:
a pair of first and second chopsticks each having a distal end;
a spoon member having a distal end and a proximal end functioned in a manner of a spoon wherein said distal end of said first chopstick is adapted for detachably attaching to said proximal end of said spoon member, so as to form a handle of said spoon member; and
a knife member having a distal end and a proximal end functioned in a manner of knife wherein said distal end of said second chopstick is adapted for detachably attaching to said proximal end of said knife member, so as to form a handle of said spoon member.

2. A 4-in-1 meal tool, as recited in claim 1, wherein said spoon member further comprises a scoop having a curved surface is formed at said distal end of said spoon member for retaining foods thereon in such a manner said scoop functions as a spoon, and at least a tooth integrally and outwardly extended from said distal end of said scoop for functioning in a manner of a fork.

3. A 4-in-1 meal tool, as recited in claim 1, wherein said knife member comprises a cutting piece integrally formed at said distal end of said knife member for cutting foods in such a manner a knife, wherein said cutting piece has a bevel edge and a plurality of tines spacedly provided on said bevel edge for cutting said foods easily.

4. A 4-in-1 meal tool, as recited in claim 2, wherein said knife member comprises a cutting piece integrally formed at said distal end of said knife member for cutting foods in such a manner a knife, wherein said cutting piece has a bevel edge and a plurality of tines spacedly provided on said bevel edge for cutting said foods easily.

5. A 4-in-1 meal tool, as recited in claim 1, further comprising an attaching means for securely attaching said first and second chopsticks to said spoon member and said knife member respectively, wherein said attaching means comprises a holder having a tapered slot provided thereon integrally formed at said proximal ends of said spoon member and knife member respectively such that said distal ends of said first and second chopsticks are fittedly inserted into said tapered slots of said holders respectively.

6. A 4-in-1 meal tool, as recited in claim 2, further comprising an attaching means for securely attaching said first and second chopsticks to said spoon member and said knife member respectively, wherein said attaching means comprises a holder having a tapered slot provided thereon integrally formed at said proximal ends of said spoon member and knife member respectively such that said distal ends of said first and second chopsticks are fittedly inserted into said tapered slots of said holders respectively.

7. A 4-in-1 meal tool, as recited in claim 3, further comprising an attaching means for securely attaching said first and second chopsticks to said spoon member and said knife member respectively, wherein said attaching means comprises a holder having a tapered slot provided thereon integrally formed at said proximal ends of said spoon member and knife member respectively such that said distal ends of said first and second chopsticks are fittedly inserted into said tapered slots of said holders respectively.

8. A 4-in-1 meal tool, as recited in claim 4, further comprising an attaching means for securely attaching said first and second chopsticks to said spoon member and said knife member respectively, wherein said attaching means comprises a holder having a tapered slot provided thereon integrally formed at said proximal ends of said spoon member and knife member respectively such that said distal ends of said first and second chopsticks are fittedly inserted into said tapered slots of said holders respectively.

9. A 4-in-1 meal tool, as recited in claim 5, wherein each of said holders has an inner threaded portion provided on a circumferential surface of said tapered slot for screwing with an outer threaded portion provided on an outer circumferential surface of said first and second chopsticks respectively.

10. A 4-in-1 meal tool, as recited in claim 6, wherein each of said holders has an inner threaded portion provided on a circumferential surface of said tapered slot for screwing with an outer threaded portion provided on an outer circumferential surface of said first and second chopsticks respectively.

11. A 4-in-1 meal tool, as recited in claim 7, wherein each of said holders has an inner threaded portion provided on a circumferential surface of said tapered slot for screwing with an outer threaded portion provided on an outer circumferential surface of said first and second chopsticks respectively.

12. A 4-in-1 meal tool, as recited in claim 8, wherein each of said holders has an inner threaded portion provided on a circumferential surface of said tapered slot for screwing with an outer threaded portion provided on an outer circumferential surface of said first and second chopsticks respectively.

13. A 4-in-1 meal tool, as recited in claim 4, wherein said first and second chopsticks each has a tapered distal end.

14. A 4-in-1 meal tool, as recited in claim 8, wherein said first and second chopsticks each has a tapered distal end.

15. A 4-in-1 meal tool, as recited in claim 12, wherein said first and second chopsticks each has a tapered distal end.
